(19) United States
(12) Patent Application Publication
(10) Pub. No.: US 2002/0055383 A1
(43) Pub. Date: May 9, 2002

(54) Game system and program

(75) Inventors: Akio Onda, Warabi-shi (JP); Kyoko Endo, Yokohama (JP)

Correspondence Address: OLIFF & BERRIDGE, PLC, P.O. BOX 19928, ALEXANDRIA, VA, 22320, US

(73) Assignee: NAMCO LTD., Tokyo (JP)

(21) Appl. No.: 09/983,470

(22) Filed: Oct. 24, 2001

Related U.S. Application Data
(63) Continuation of application No. PCT/JP01/01086, filed on Feb. 15, 2001.

(30) Foreign Application Priority Data
Feb. 24, 2000 (JP) 2000-48336
Feb. 24, 2000 (JP) 2000-48337

(51) Int. Cl. A63F 13/00

(52) U.S. Cl. 463/36

(57) ABSTRACT

To provide a game system and program which can easily detect an action of a player and which can properly evaluate the operation of the player, the game system includes a detection section which detects the operation of the player relating to an image of operational instruction displayed according to a music through the inclinations of operation sections, a judgment section which judges the conformance of the player's operation, based on operational instruction data which indicates the player's operational information, operational instruction image and operating timing, a sound generating section and sound output section which generates and outputs effect sounds respectively, and an image generating section and display section which generates and displays the operational instruction image respectively based on the operational instruction data.

Japanese Patent Application No. 2000-48336, filed on Feb. 24, 2000, is hereby incorporated by reference in its entirety. Japanese Patent Application No. 2000-48337, filed on Feb. 24, 2000, is hereby incorporated by reference in its entirety. International Application No. PCT/JP01/01086, filed on Feb. 15, 2001, is hereby incorporated by reference in its entirety.

### FIELD OF THE INVENTION

The present invention relates to a game system and program which can provide an operational instruction based on a music being played to a player and evaluate the operation of the player according the operational instruction.

### DESCRIPTION OF THE RELATED ART

Such a game system that can provide an operational instruction based on music being played to a player and evaluate the operation of the player according the operational instruction has been realized.

There may be considered various techniques of detecting the operation of the player, such as a technique of detecting the depression of button, a technique of detecting the stepping motion of the player on a pedestal, a technique of detecting the action of the player through a camera which images it and other techniques.

However, the depression of button is similar to that of the conventional game systems other than the music game system, such as shooting game systems and so on. This does not provide any interest to the player.

The detection of player's stepping on the pedestal may provide certain interest to the player, but only the motions of the player's feet is evaluated. This is less effective for the music game wherein the motions of the player's arms are important.

### SUMMARY

In view of the problems mentioned above, an object of the present invention is to provide a game system and program which can easily and simply detect the action of a player and particularly the motions of the player's arms and properly evaluate the motions.

(1) To this end, the present invention provides a game system comprising:

sound generation means which generates a sound for game music;

operational instruction means which gives a player an operational instruction associated with a sound for game music;

a plurality of input means which detect a motion of the player and inputs operational information of the player; and

evaluation means which evaluates an operation of the player according to the operational instruction, based on a content of the operational instruction and the operational information,

wherein each of the input means includes:

an operation section which moves along with the player; and

a detection section which detects at least one of movement volume, inclination, position and vibration of the operation section.

(2) The present invention also provides a game system comprising:

a sound generation section which generates a sound for game music;

a motion instruction section which gives a player a motion instruction associated with a sound for game music;

a plurality of input sections which detect a motion of the player and inputs motion information of the player; and

an evaluation section which evaluates a motion of the player according to the motion instruction, based on a content of the motion instruction and the motion information,

wherein each of the input sections includes:

an operation section which moves along with the player; and

a detection section which detects an inclination in a rightward-leftward direction and an upward-downward direction of the operation section.

(3) The present invention also provides a game system comprising:

a sound generation section which generates a sound for game music;

a motion instruction section which gives a player a motion instruction associated with a sound for game music;

a plurality of input sections which detect a motion of the player and inputs motion information of the player; and

an evaluation section which evaluates a motion of the player according to the motion instruction, based on a content of the motion instruction and the motion information,

wherein each of the input sections includes:

an operation section which moves along with the player; and

a detection section which detects an inclination in a rightward-leftward direction and an upward-downward direction of the operation section,

wherein the motion instruction section performs at least one of an instruction of moving a hand in a rightward-leftward direction or an upward-downward direction, an instruction of rotating a hand clockwise or counter-clockwise and an instruction of moving a hand in a zigzag manner, as the motion instruction,

wherein the operation section which moves along with the player's arm, and

wherein the input section detects a change of an inclination of the arm based on information from the detection section.

(4) The present invention also provides a program embodied in a carrier wave or on an information storage medium, the program being for an evaluation of a player's operation relating to an operational instruction associated with a sound for game music, and for a computer to realize:

sound generation means which generates a sound for game music;

operational instruction means which gives a player an operational instruction associated with a sound for game music; and

evaluation means which evaluates an operation of the player according to the operational instruction, based on a content of the operational instruction and operational information of the player from a given input means,

wherein the input means includes:

an operation section which moves along with the player; and

a detection section which detects at least one of movement volume, inclination, position and vibration of the operation section.

(5) The present invention also provides a program embodied in a carrier wave or on an information storage medium, the program being for an evaluation of a player's operation relating to a motion instruction associated with a sound for game music, and for a computer to realize:

a sound generation section which generates a sound for game music;

a motion instruction section which gives a player a motion instruction associated with a sound for game music; and

an evaluation section which evaluates motion of the player according to the motion instruction, based on a content of the motion instruction and the motion information from a given input sections,

wherein the input sections includes:

an operation section which moves along with the player; and

a detection section which detects an inclination in a rightward-leftward direction and an upward-downward direction of the operation section.

(6) The present invention also provides a program embodied in a carrier wave or on an information storage medium, the program being for an evaluation of a player's motion relating to a motion instruction associated with a sound for game music, and for a computer to realize:

a sound generation section which generates a sound for game music;

a motion instruction section which gives a player a motion instruction associated with a sound for game music; and

an evaluation section which evaluates motion of the player according to the motion instruction, based on a content of the motion instruction and the motion information from a given input section,

wherein the input section includes:

an operation section which moves along with the player; and

a detection section which detects an inclination in a rightward-leftward direction and an upward-downward direction of the operation section,

wherein the motion instruction section performs at least one of an instruction of moving a hand in a rightward-leftward direction or an upward-downward direction, an instruction of rotating a hand clockwise or counter-clockwise and an instruction of moving a hand in a zigzag manner, as the motion instruction,

wherein the operation section which moves along with the player's arm, and

wherein the input section detects a change of an inclination of the arm depend on information from the detection section.

According to the present invention, the operation of the player can be grasped by detecting at least one of the movement volume, inclination, position and vibration in each of the operation sections which are in contact with part of the player's body or garment.

Thus, the action of the player's arms can be grasped, for example, when the player swings his or her arms on which bracelet-shaped operation sections are attached. It is of course that if such operation sections are attached on various body parts such as legs, head, hip, fingers and the like other than the arms, the motions in the respective parts can similarly be grasped.

By adopting such a technique, a game can be provided which is more amusing than the conventional stepping-only or button depression type games and which can evaluate the action in various body parts such as arms, hip and so on.

Such operation sections may include, for example, an analog output type rotary encoder, a digital output type rotary encoder using a photo-interrupter, an inclination sensor having a mercury switch, a geomagnetism sensor, a gyro and so on.

Since the action of the player can be thus detected by using simple detection means such as sensors and so on, the influence by noise can be reduced and the action of the player can accurately and simply be detected, in comparison with the detection of player's action by imaging it through a camera and processing the image.

The sound for game music may include, for example, a musical instrument sound, a text sound, a chorus sound, an accompaniment sound, an effect sound, a BGM (Back Ground Music) and so on.

(7) In the game system and the program, it is preferred that the operation section includes a detachable section which is detachable to each body part of the player, and

the detection section detects at least one of movement volume, inclination, position and vibration of each body part of the player on which the operation section is attached with the detachable section.

For example, when operation sections are attached on the player's arms, the motions of the player's arms can be detected in a simple manner. The motions of the player's arms, which would hardly be operationally instructed and evaluated, can be subjected to the operational instruction and evaluation.

Desirable music games for the detection of the arm's motion may be, for example, hula games, Para Para dance games, flamenco games and so on.

(8) In the game system and the program, it is preferred that the operation section includes a step pedestal having an input indication mark corresponding to the operational instruction, and

the detection section includes means which detects a contact or pressure of the player against the step pedestal.

Thus, the action of the player' feet can be detected in a simple manner.

(9) The present invention further provides a game system comprising:

sound generation means which generates a sound for game music;

operational instruction means which gives a player an operational instruction associated with a sound for game music;

input means which detects a motion of the player and inputs operational information of the player; and

evaluation means which evaluates an operation of the player according to the operational instruction, based on a content of the operational instruction and the operational information,

wherein the input means includes a detection section which detects at least one of movement volume, inclination and position of each body part of the player, without contacting with the player.

(10) The present invention further provides a game system comprising:

a sound generation section which generates a sound for game music;

a motion instruction section which gives a player a motion instruction associated with a sound for game music;

a detection section which detects a motion of the player and inputs motion information of the player; and

an evaluation section which evaluates a motion of the player according to the motion instruction, based on a content of the motion instruction and the motion information,

wherein the detection section detects at least one of movement volume, inclination and position of each body part of the player, without contacting with the player,

wherein the motion instruction section performs an instruction using one or more instruction marks which instructs a motion of each body part of the player and one or more input marks which indicates a motion timing, and

wherein the evaluation section includes a judgment section which judges a conformance of a motion by the player to a given condition when there is a given positional relationship between the instruction mark and the input mark.

(11) The present invention further provides a game system comprising:

a sound generation section which generates a sound for game music;

a motion instruction section which gives a player a motion instruction associated with a sound for game music;

a detection section which detects a motion of the player and inputs motion information of the player; and

an evaluation section which evaluates a motion of the player according to the motion instruction, based on a content of the motion instruction and the motion information,

wherein the motion instruction section instructs a motion of each body part of the player, and

wherein the detection section detects at least one of movement volume, inclination and position of each body part of the player, without contacting with the player.

(12) The present invention also provides a program embodied in a carrier wave or on an information storage medium, the program being for an evaluation of a player's operation relating to an operational instruction associated with a sound for game music, and for a computer to realize:

sound generation means which generates a sound for game music;

operational instruction means which gives a player an operational instruction associated with a sound for game music; and

evaluation means which evaluates an operation of the player according to the operational instruction, based on a content of the operational instruction and operational information of the player from a given input means,

wherein the input means includes a detection section which detects at least one of movement volume, inclination and position of each body part of the player, without contacting with the player.

(13) The present invention also provides a program embodied in a carrier wave or on an information storage medium, the program being for an evaluation of a player's motion relating to an motion instruction associated with a sound for game music, and for a computer to realize:

a sound generation section which generates a sound for game music;

a motion instruction section which gives a player a motion instruction associated with a sound for game music;

a detection section which detects a motion of the player and inputs motion information of the player; and

an evaluation section which evaluates a motion of the player according to the motion instruction, based on a content of the motion instruction and the motion information,

wherein the detection section detects at least one of movement volume, inclination and position of each body part of the player, without contacting with the player,

wherein the motion instruction section performs an instruction using one or more instruction marks which instructs a motion of each body part of the player and one or more input marks which indicates a motion timing, and

wherein the evaluation section includes a judgment section which judges a conformance of a motion by the player to a given condition when there is a given positional relationship between the instruction mark and the input mark.

(14) The present invention also provides a program embodied in a carrier wave or on an information storage medium, the program being for an evaluation of a player's motion relating to an motion instruction associated with a sound for game music, and for a computer to realize:

a sound generation section which generates a sound for game music;

a motion instruction section which gives a player a motion instruction associated with a sound for game music;

a detection section which detects a motion of the player and inputs motion information of the player; and

an evaluation section which evaluates a motion of the player according to the motion instruction, based on a content of the motion instruction and the motion information,

wherein the motion instruction section instructs a motion of each body part of the player, and

wherein the detection section detects at least one of movement volume, inclination and position of each body part of the player, without contacting with the player.

The present invention can grasp the action of the player by detecting at least one of the movement volume, inclination, position and vibration in each of various body parts (such as arms and the like) in the player, without contacting with the player.

For example, the actions of the player's arms can be grasped when they are swung by the player. It is of course that the body parts include feet, head, hip, fingers and others in addition to arms, all the actions of these body parts can be grasped. It is particularly preferred that the motions of the arms are grasped.

Desirable music games for the detection of the arm's motion may be, for example, a hula game, a Para Para dance game, a flamenco game and so on.

By adopting such a technique, a game can be provided which is more amusing than the conventional stepping-only or button depression type games and which can evaluate the action in various body parts such as arms, hip and so on.

The present invention can set the number of operations to be performed by the player, for example, the number of rotations in the player's hands. The present invention can provide an operational instruction, for example, for causing the player to a predetermined operation by three times within a predetermined time period. The player is thus required to perform the instructed operations exactly within the limited time period. The player can enjoy a game in amore strained state.

If the operational information relating to the right-hand and left-hand operations and the right-feet and left feet operations are provided, the order or combination of the actions relating to both hands and both feet can be evaluated comprehensively.

The sound for game music may include, for example, a musical instrument sound, a text sound, a chorus sound, an accompaniment sound, an effect sound, a BGM (Back Ground Music) and so on.

It is also preferable that the detection section includes a plurality of infrared sensors or a plurality of proximity sensors.

(15) In the game system and the program, it is preferred that the detection section includes a plurality of infrared sensors or a plurality of proximity sensors.

The action of the player can remotely be grasped by means of the infrared or proximity sensors.

More particularly, the action of the player can be grasped, for example, by providing a plurality of infrared sensors around a dance area to detect the action of the player or by providing a plurality of proximity sensors on the top and bottom of a housing to detect the proximities of the player's hands and feet to the housing.

(16) In the game system and the program, it is further preferred that the input means includes imaging means, and

the detection section detects an action of the player, based on imaging information from the imaging means.

Thus, the action of the player can remotely be grasped through the imaging information.

(17) In the game system and the program, it is further preferred that the operational instruction means provides one or more operational instructions to a plurality of operation sections.

If a plurality of operational instructions are provided, the player will be involved in the game to properly select one of the operations and to perform that operation at its optimal timing. This enables the game to be more amusing.

The operational instructions may include an instruction of rotating the arms, an instruction of moving the arms in all the directions, an instruction of moving the feet on a mat and other suitable instructions.

(18) In the game system and the program, it is further preferred that the operational instruction means displays at least one of a schematic display including a color, pattern or input action, and number of input as the operational instruction.

(19) In the game system and the program, it is further preferred that the operational instruction means displays a sample of operational instruction imitating the action of the player as the operational instruction before the input of the player begins to be received.

Thus, the operational instruction can easily be understood by the player through the sample of operational instruction which is pre-displayed to imitate the action of the player. The player can confirm the actual action thereof and thus play the game while enjoying the pictures relating to the sample of operational instruction and his or her action.

(20) In the game system and the program, it is further preferred that the operational instruction means performs an instruction using one or more instruction marks which instructs an input operation and one or more input marks which indicates an input timing, and

the evaluating means includes judgment means which judges a conformance of an operation by the player to a given condition when there is a given positional relationship between the instruction mark and the input mark.

Thus, any optimal timing at which the player should perform an operation can be indicated to the player. Such timing may include timing having a certain range as measured from the start of evaluation to the finish of operation in addition to timing at a certain time point. For example, an operational instruction may cause the player to perform a predetermined operation during a time period between a starting point and a finishing point. The player is thus required to perform the operation exactly getting the timing right. The player can enjoy a tense game.

(21) In the game system and the program, it is further preferred that the input mark schematically shows a duration of input or an area in which timing is judged.

Thus, the player can be instructed to continue his or her same operation for few seconds, for example.

(22) In the game system and the program, it is further preferred that the operational instruction means displays a mark for an input judgement and which indicates at least one of input timing, input period, number of inputs, direction of input and magnitude of input as the instruction mark, and

the judgment means judges the conformance of the operation by the player to a given condition when there is a given positional relationship between the instruction mark and the input mark.

Thus, the number of particular operations such as rotations of hands and soon can be set to the player. For example, an operational instruction of making a predetermined operation three times can be provided within a predetermined time period. Thus, the player must perform the instructed operation with the limited time period and can enjoy a more tense game.

(23) In the game system and the program, it is further preferred that the operational instruction means performs at least one of an instruction of moving a hand in a rightward-leftward direction or an upward-downward direction, an instruction of rotating a hand clockwise or counterclockwise and an instruction of moving a hand in a zigzag manner, as the operational instruction.

Thus, various complicated motions of the arms can be instructed to the player by detecting and evaluating them.

Therefore, an amusing game which will not spoil the interest of the player in the game can be provided by performing various operational instructions including the instruction of moving the hands in the horizontal or vertical direction and the other instructions.

(24) In the game system and the program, it is further preferred that the detection section includes a sensor which outputs digital information including at least one of movement volume, inclination, position and vibration of each body part of the player on which the operation section is attached with the detachable section.

Thus, the action of the player can easily be digitized since it can be represented as digital information.

(25) In the game system and the program, it is further preferred that the detection section includes a sensor which outputs analog information including at least one of movement volume, inclination, position and vibration of each body part of the player on which the operation section is attached with the detachable section.

Thus, the continuous action of the player can easily be grasped since it can be represented as analog information.

(26) In the game system and the program, the detection section may detect at least one of movement volume and inclination of each body part of the player based on a plurality of infrared sensors or a plurality of proximity sensors.

### BRIEF DESCRIPTION OF THE DRAWINGS

FIG. 1 is an outline drawing of a game system according to this embodiment.

FIG. 2 is a functional block diagram of a game system according to this embodiment.

FIG. 3 is a schematic block diagram of operational instruction data according to this embodiment.

FIG. 4 is a flow chart showing a flow of processing according to this embodiment.

FIG. 5 is a view showing a hardware configuration of a game system according to this embodiment.

FIG. 6 is a view showing a game image according to this embodiment.

FIG. 7 is a view showing another game image according to this embodiment.

FIG. 8 is a view showing still another game image according to this embodiment.

FIG. 9 is a view showing a further game image according to this embodiment.

FIG. 10 is a block diagram of a vibration sensor.

FIG. 11 is an outline drawing of a further game system according to this embodiment.

FIG. 12 is a functional block diagram of a further game system according to this embodiment.

FIG. 13 is a schematic diagram illustrating the detection of the player's action.

FIG. 14 is a view showing the hardware configuration of a further game system according to this embodiment.

FIG. 15 is a view showing a further game image according to this embodiment.

FIG. 16 is a perspective view of a further game system comprising a camera.

### DETAILED DESCRIPTION OF THE INVENTION

The present invention will now be described with reference to the drawings in connection with a case where it is applied to a music game system.

Explanation on a Game System Contacting with a Player

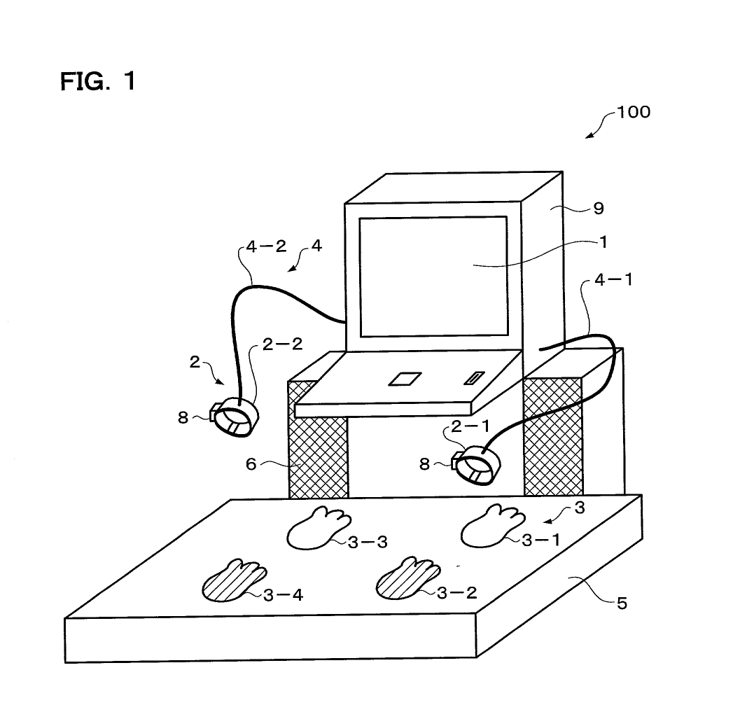

FIG. 1 shows an outline drawing of a game system 100 according to this embodiment.

A music game of this embodiment is a music game for hula. When the game system 100 is outputting a BGM (Back Ground Music) for hula, a player manipulates operation sections according to an operational input instruction which is displayed in association with the BGM. If the operations of the player fit the operational instruction, an effect sound such as the voice of a singer and so on will be outputted from the game system 100.

The game system 100 includes a loud speaker 6 that is one part of sound generation means which generates the BGM and effect sound and a display 1 that is one part of operational instruction means which performs the operational instruction associated with the BGM relative to the player.

The player inserts a coin through a coin input port and plays a game after a desired piece of music has selected from a menu displayed on the display 1 through operation buttons.

In particular, when the music game is one involving many motions of arms such as hula, it is important for appealing to the player by interest of the game that these motions of arms are instructed and adequately evaluated.

This embodiment is to detect a stepping motion and motions of hands.

As operation sections, the game system 100 comprises arm-operating bands 2 and foot-operating panels 3, all of which form part of plural input means which detects the action of the player and for inputting the operational information relating to the player.

The player puts one of the arm-operating bands 2-1 on his or her right arm and the other arm-operating band 2-2 on his or her left arm. Each of the arm-operating bands 2 is in the form of a tape which can detachably attached on one arm.

Each of the arm-operating bands 2 includes an inclination sensor 8 which includes a mercury switch and which functions as detection means which detects the inclination in the player's arm.

The foot-operating panels 3 are placed on an operation pedestal 5 and comprise right foot-operating panels 3-1, 32 and left foot-operating panels 3-3, 3-4. The tops of the foot-operating panels 3-1, 3-2, 3-3 and 3-4 have instruction marks which are respectively different.

The player must view an operational instruction displayed on the display 1. If that operational instruction is for arms, the player swingingly moves his or her arms to manipulate the arm-operating bands 2. If the operational instruction is for feet, the player steps on the foot-operating panels 3 which have the instruction marks corresponding to the operational instruction.

The operational information provided by the player through the arm-operating bands 2 is fed to a processing section in a housing 9 through cables 4 which are connected with the arm-operating bands 2. On the other hand, the operational information provided by the player through the foot-operating panels 3 is fed to the processing section in the housing 9 which is also connected to the operation pedestal 5.

The processing section in the housing 9 comprises evaluating means which evaluates the operation of the player according to the operational instruction, based on the contents of the operational instruction and player's operational information.

This embodiment comprises a detection section located in each of the arm-operating bands 2 for detecting the inclination thereof. More particularly, each of the detection sections includes four mercury switches for sensing inclinations in the vertical and horizontal directions.

In such an arrangement, the game system 100 can grasp the motions of the player's arms by detecting the inclinations in the arm-operating bands 2 attached on the player's arms.

Thus, a game can be provided which is more amusing than the conventional stepping-only or button depression type games and which can evaluate the action in various body parts such as arms, hip and so on.

In particular, a variety of operational instructions including the horizontal motion, vertical motion and rotation the hands can be performed since the inclinations in the arm-operating bands 2 attached on the player's arms can be detected.

Thus, the player can longer enjoy the game without spoiling of the player's interest.

Functional blocks for realizing such functions will be described below.

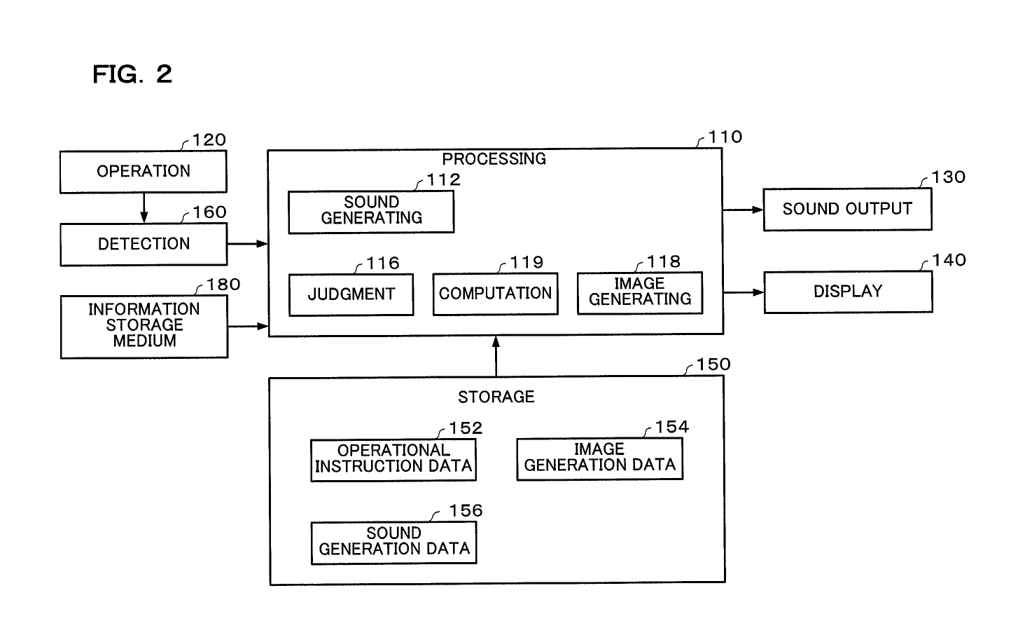

FIG. 2 is a functional block diagram of a game system 100 according to this embodiment.

The game system 100 comprises an operation section 120 including arm-operating bands 2 and foot-operating panels 3 operated by the player according to an operational input instruction which is displayed on the screen in association with a music being played, a detection section 160 for detecting the inclinations or the like in the operation section 120 to detect the player's action and a processing section 110 for generating images and voices and judging the conformance in the player's operation, based on the operational information from the detection section 160.

The processing section 110 comprises a judgment section 116 for judging the conformance in the player's operation, based on the operational information delivered from the arm-operating bands 2 and others, the contents of the operational instruction and operational instruction data 152 for indicating timings, and a sound generating section 112 for generating the effect sound using sound generation data 156, based on the judgment in the judgment section 116.

The processing section 110 also comprises an image generating section 118 for displaying operational input instructions, characters and the like, based on the operational instruction data 152 and image generation data 154.

The processing section 110 further comprises a computation section 119 for computing scores and the like based on the judgment result.

The game system 100 further comprises a display section 140 for displaying the generated image and a sound output section 130 for outputting the generated sound.

The operational instruction data 152, image generation data 154 and sound generation data 156 are stored in a storage section 150.

In the other aspect, the game system 100 comprises the sound generating section 112 and sound output section 130 which function as sound generation means which generates game music sounds; the image generating section 118 and display section 140 which function as operational instruction means which performs the operational instruction associated with the game music sounds; the judgment section 116, computation section 119, image generating section 118 and display section 140 which function as evaluation means which evaluates the player's operation according to the operational instruction; and the operation section 120 and detection section 160 which function as plural input means which inputs the operational information relating to the player.

These sections can be realized by reading information out of an information storage medium 180.

The aforementioned information may include, for example, information for realizing the sound generation means which generates the game music sound, the operational instruction means which performs the operational instruction associated with the game music sound, and the evaluation means which detects the contents of the operational instruction and player's action and for evaluating the player's operation according to the operational instruction, based on the operational information from the plural input means which inputs the operational information relating the player.

The information stored in the information storage medium 180 may be replaced by information embodied in carrier wave. In other words, the game system can realize various functions mentioned above by reading the information from a predetermined host terminal or the like through a network, rather than from the information storage medium 180.

The information stored in the information storage medium 180 may also be replaced by a program for realizing the means.

The actual operational instruction will be described in a concrete manner.

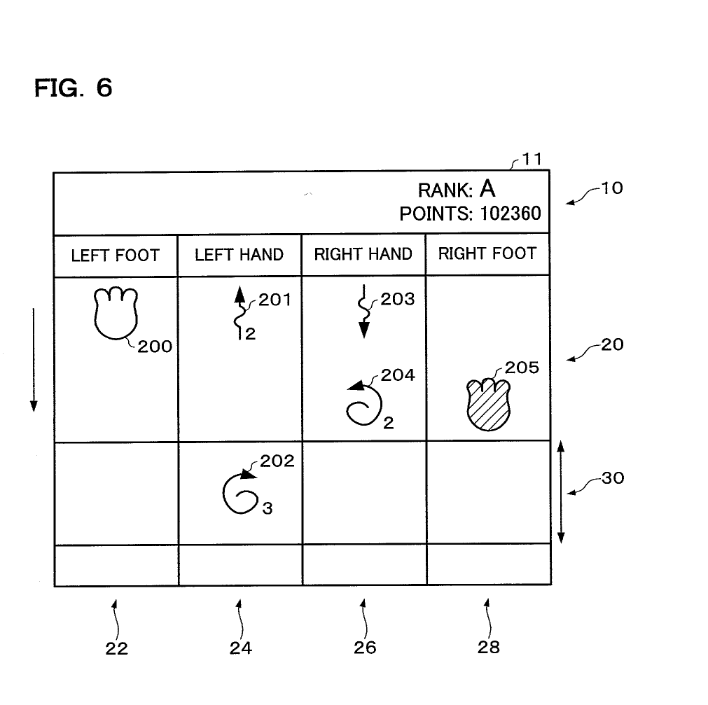

FIG. 6 is a view showing a game image according to this embodiment.

The game image 11 includes an evaluation area 10 for displaying ranks such as “Rank A” and the like and scores such as “102360 Points” and the like, an instruction area 20 for displaying input instructions 200 to 205 that are instruction marks showing operational instructions to the player, and a timing area 30 which displays an input instruction for indicating that an operation must be performed for each of the input instructions 200 to 205 in the instruction area.

The rank such as “Rank A” rises from C through B toward A as the evaluation relative to the player's operation rises and falls from A through B toward C as the evaluation falls.

If the player performs an operation agreeing with the instruction mark while it is on the input mark, a higher evaluation can be provided.

The scores such as “102360 Points” also rises as the evaluation for the player's operation rises and falls as the evaluation falls.

The instruction area 20 includes four sub-areas corresponding to the respective operation means, left foot instruction sub-area 22, left hand instruction sub-area 24, right hand instruction sub-area 26 and right foot instruction sub-area 28.

Each of the input instructions 200 to 205 appears on the top of the corresponding instruction sub-area and moves downwardly and disappears at a point when it passes through the timing area 30.

The timing area 30 has a predetermined range such that the player may perform the operation corresponding to each of the input instructions 200 to 205 while they fall within the range.

In order to generate a game image as shown in FIG. 6, the operational instruction data 152 is of the following data structure.

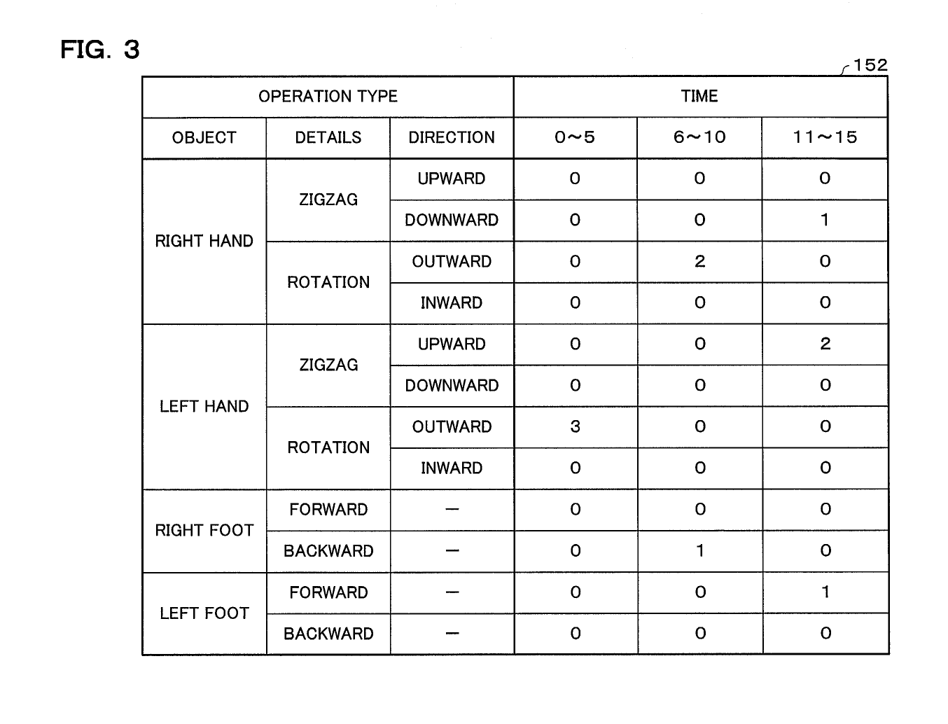

FIG. 3 shows a schematic diagram of an operational instruction data structure 152 according to this embodiment.

The operational instruction data structure 152 has two items, that is, “OPERATION TYPE” showing the contents of the operational instruction and “TIME” showing timing and frequency in operation.

The “OPERATION TYPE” is divided into “OBJECT”, “DETAILS” and “DIRECTION”.

The “OBJECT” shows an object to be operated. More particularly, it may include “RIGHT HAND”, “LEFT HAND”, “RIGHT FOOT”, “LEFT FOOT” and so on, for example.

The “DETAIL” shows the details of the “OBJECT” and an operating method and operational position. More particularly, the “DETAILS” may include operating methods such as “ZIGZAG” and “ROTATION” and operational positions such as “FORWARD” and “BACKWARD”.

The “TIME” is divided into “0 to 5” seconds, “6 to 10” seconds and “11 to 15” seconds.

Thus, the operational instruction data structure 152 is structured such that the operational instruction can be performed depending on the time point at which the game is executed, by using the “OPERATION TYPE” and “TIME” as indexes.

More particularly, FIG. 6 shows the input instruction 202 in the timing area 30 and a numerical value 3 added to the input instruction 202. This means that the contents of the operational instruction shown by the input instruction 202 must be performed three times while the input instruction 202 exists in the timing area 30. The contents of the operational instruction shown by the input instruction 202 represent “rotate the left hand three times outward”.

To perform such an operational instruction, the operational instruction data structure 152 of FIG. 3 instructs that an operation in which the “OBJECT” is “LEFT HAND”; the “DETAILS” is “ROTATION”; and the “DIRECTION” is “OUTWARD” should be executed three times within “0 to 5” seconds.

All the other operations are represented by “0” (zero) during the time of “0 to 5” seconds.

If the operational instruction image is generated based on the operational instruction data 152, only the input instruction 202 is displayed in the timing area 30 during the time period of 0 to 5 seconds counted from the start of the game.

The similar procedure will be performed relating to the operations to be executed for six or more seconds. Although the operational instruction data 152 is simplified to have data up to 15 seconds, the operational instruction data 152 may actually include and hold data relating to at least one piece of music.

The flow of processing using the aforementioned judgment section 116 and others will be described below.

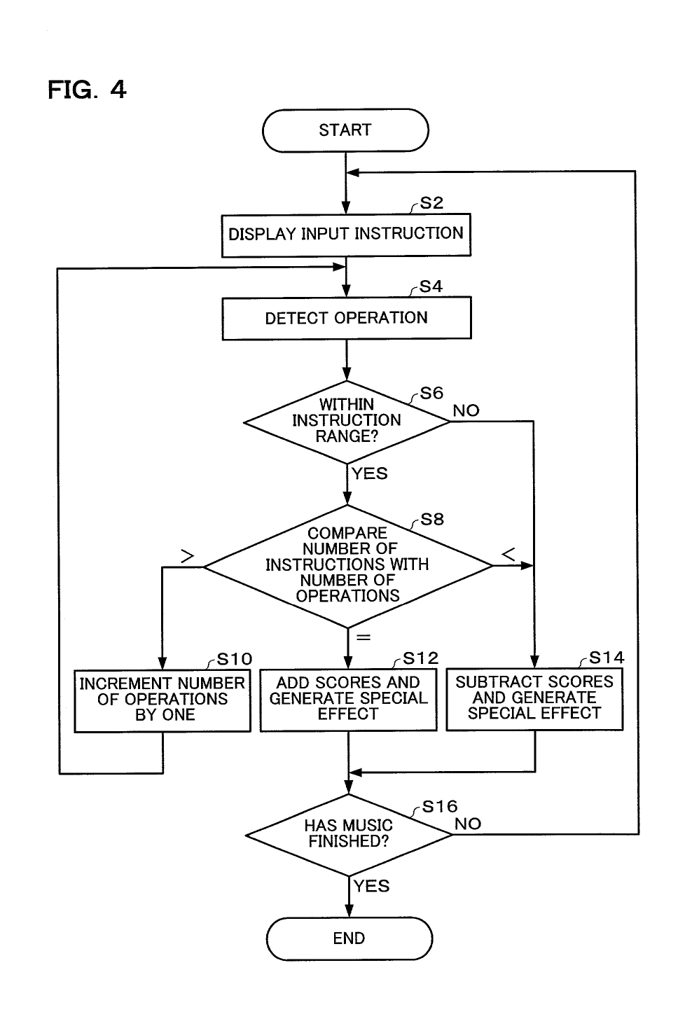

FIG. 4 is a flow chart illustrating a flow of processing according to this embodiment.

The image generating section 118 and display section 140 display the input instructions an others, based on the operational instruction data 152 (step S2).

A player judges objects to be operated, operating manners and operational timings in the input instructions and others and manipulates the arm-operating bands 2 and foot-operating panels 3 according the operational instruction.

For example, when the player operates the arm-operating bands 2, the mercury switches each of which functions as part of the detection section 160 included in the corresponding inclination sensor 8 detect the motions of the arm-operating bands 2. (step S4).

More particularly, with the input instruction 202, if the inclinations are detected by the mercury switch in the left arm-operating band 2-2 in the order of left, up, right and down, it may be judged that the left hand of the player is rotated outward.

Next, the judgment section 116 judges whether or not such an operation is performed within the instructed range, that is, whether or not the inclinations are detected in the order of left, up, right and down while the input instruction 202 exists in the timing area 30 shown in FIG. 6 and more particularly for 0 to 5 seconds (step S6).

If such a condition is fulfilled, the judgment section 116 further compares the number of instructions with the number of operations actually made by the player (step S8).

If the number of instructions coincides with the number of operations actually made by the player, the computation section 119 adds the scores, the image generating section 118 and display section 140 change (or upgrade) the rank and the sound generating section 112 and sound output section 130 output an effect sound for conformance, thereby generating the special effect (step S12).

If the number of instructions is more than the number of operations actually made by the player, the number of operations is incremented by one (1) (step S10). Thereafter, the next detection of operation is executed (step S4).

If the number of instructions is less than the number of operations actually made by the player, it is judged that the player wrongly makes the operations. Thus, the computation section 119 subtracts the scores, the image generating section 118 and display section 140 change (or downgrade) the rank and the sound generating section 112 and sound output section 130 output an effect sound for inconformance, thereby generating a special effect (step S14).

Even if an operation of the player out of the instructed range is detected, the scores are subtracted (step S14).

Such a procedure will be repeated until that piece of music terminates (step S16).

According to this embodiment, thus, the action of the player's arms can be grasped when the arm-operating bands 2 attached on the player's arms are swung by the player.

By adopting such a technique, a game can be provided which is more amusing than the conventional stepping-only or button depression type games and which can evaluate the action in various body parts such as arms, hip and so on.

Since the action of the player can be detected by using simple detection means such as sensors and so on, the influence of noise can be reduced and the action of the player can accurately and simply be detected, in comparison with the detection of player's action by imaging it through a camera and processing the image.

Since the foot-operating panels 3 functioning as a stepping pedestal having input instruction marks corresponding to the operational instructions is provided in addition to the arm-operating bands 2, the action of the player's feet can also simply be detected by detecting the stepping action of the player on the foot-operating panels 3 through pressure-sensitive sensors or the like.

As shown in FIG. 6, furthermore, this embodiment is designed to display, on the display 1, various types of input instructions 200 which correspond to the legs and arms and which correspond to a plurality of operation types additionally containing rotations, directions and so on.

If a plurality of operational instructions are provided, the player will be involved in the game to properly select one of the operations and to perform that operation at its optimal timing. This enables the game to be more amusing.

This embodiment provides a separate operational instruction for each of the operation sections in the arm-operating bands 2 and foot-operating panels 3 and causes the judgment section 116 to evaluate the conformance between the contents of the operational instruction and the actual operations made by the player.

Therefore, a more amusing game can be provided in which various instructions and operations are provided by making various operational instructions to the respective operation sections.

Particularly, since such operational instructions can be provided in real time, the player can enjoy the game in a tenser manner.

Moreover, this embodiment indicates a timing whereat the player should perform an operation as an operational instruction as shown in the timing area 30 of FIG. 6 and causes the judgment section 116 to evaluate the conformance between the contents of the operational instruction and the actual operation made by the player.

Thus, an operational instruction may be performed which causes a predetermined operation to execute between a starting point and a finishing point. As a result, the player must exactly perform the operation at that timing and can thus enjoy the game in a tenser manner.

In the operational instruction data 152 of FIG. 3, the number of predetermined operations to be made by the player within a predetermined time period as operational instructions and images such as the input instruction 202 in which the contents and number of the operational instructions are integrated are generated by the image generating section 118.

The judgment section 116 then evaluates the conformance between the contents of the operational instructions and the number of operations actually made by the player.

In such a manner, the game system can instruct the number of particular operations to be made by the player thereto. Thus, the player is required to made the instructed operations within the limited time period, so that the player can enjoy the game in a tenser manner.

A description will be made of a hardware configuration in each of the primary parts in the functional block shown in FIG. 2.

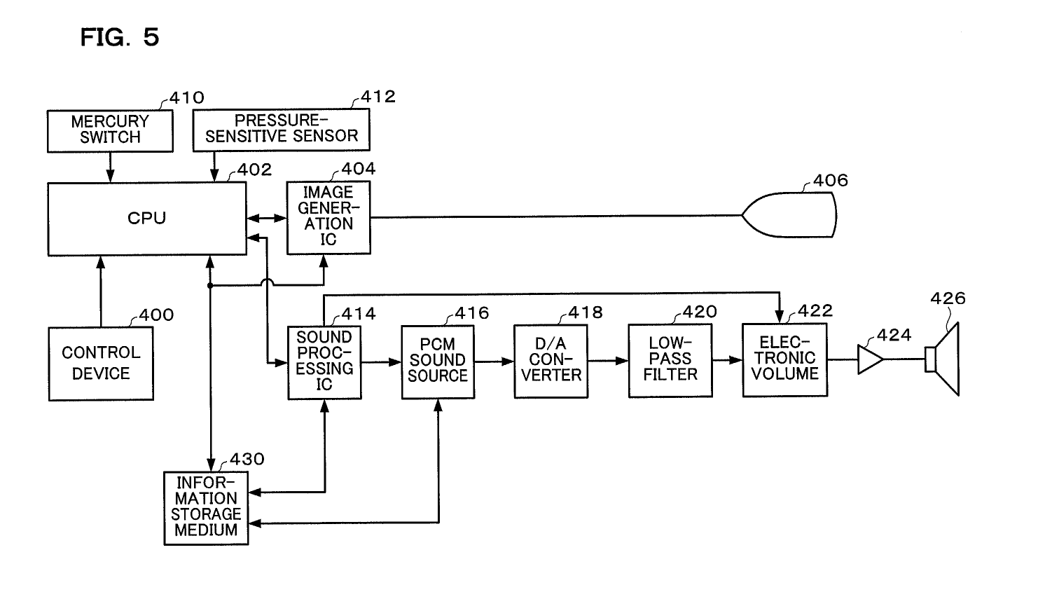

FIG. 5 is a view showing a hardware configuration of a game system according to this embodiment.

An information storage medium 430 is mainly operative to store programs, image data, sound data (including tone data, score data and waveform data) and so on. The information storage medium 430 may be in any form of CD-ROM, game cassette, IC card, MO, FD, DVD-ROM, memory and so on. For example, with the home game systems, the information storage medium for storing the game program and the like may be in any form of CD-ROM, DVD-ROM, game cassette and so on. With the arcade game systems, the information storage medium may be a memory such as ROM and the like.

A control device 400 corresponds to a control panel or the like and can be used to input player's judgment to the main system body depending on the progress of game.

A plurality of mercury switches 410 are provided in the arm-operating bands 2 while a plurality of pressure-sensitive sensor 412 are provided in the foot-operating panels 3 on the backside thereof.

A CPU 402 is to receive menu selection information from the control device 400, arm-action detection information from the mercury switches 410 and fee-action detection information from the pressure-sensitive sensor 412.

The CPU 402 performs the control of the entire game system, the processing of various data and the computation of game, based on the input signals and others inputted through the control device 400. The data and others read out of the information storage medium 430 are temporarily stored in any suitable storage means such as RAM (not shown). This RAM may also be used as a working area for the CPU 402, image generating IC 404, sound processing IC 414.

This game system further comprises the image generating IC 404 and sound processing IC 414 for optimally outputting sounds and images. Such image generating IC 404 and sound processing IC 414 may be in any form of dedicated IC, CPU or DSP, for example.

The image generating IC 404 is an integrated circuit for generating pixel information to be outputted toward the display 406, based on image data sent from RAM (not shown) or the information storage medium 430. The display 406 may be in the form of a so-called head mount display (HMD).

The sound processing IC 414 is operative to make various processings for generating game music, effect sounds, voices and others, based on the instructions from CPU 402 and the programs, tone data, score data and other data from the RAM and information storage medium 430.

A PCM sound source 416 is operative to generate and output digital sound signals toward a D/A converter 418, based on the processing result at the sound processing IC 414 and the waveform data from the information storage medium 430 and others (i.e., data representing the real physical waveforms of sounds such as drum, violin).

The D/A converter 418 converts these digital signals to analog signals which are in turn outputted therefrom toward a low-pass filter 420. The output of the low-pass filter 420 is inputted into an electronic volume 422.

The electronic volume 422 adjusts the loudness according to instructions from the sound processing IC 414. The output of the electronic volume 422 is input into a loud speaker 426 through an amplifier 424, the loud speaker 426 then externally outputting the game music, the effect sound and the voices.

Thus, the aforementioned operation section 120 may be realized by the control device 400, mercury switch 410 and pressure-sensitive type sensor 412; the information storage medium 180 and storage section 150 may be realized by the information storage medium 430; the judgment section 116 and computation section 119 maybe realized by the CPU 402; the sound generating section 112 may be realized by the sound processing IC 414, PCM sound source 416, D/A converter 418 and low-pass filter 420; the sound output section 130 may be realized by the amplifier 424, electronic volume 422 and loud speaker 426; the image generating section 118 may be realized by the image generating IC 404; and the display section 140 may be realized by the display 406.

The present invention is not limited to the aforementioned embodiment, but may be carried out in any of various other forms.

For example, if it is only want to detect the vibration in the player's arms, the mercury switches may be replaced by vibration sensors.

FIG. 10 is a view showing the structure of a vibration sensor 411.

The vibration sensor 411 comprises a hollow casing 411a, a spherical weight contact 411b of metal, a support member 411c for supporting the weight contact 411b, and an insulative anchoring member 441d for fixedly holding the support member 411c on the casing 411a.

The casing 411a may be made of metal or include a metallic coating over the inner wall of the hollow portion thereof. The metallic surface is grounded. The support member 411c may be of rod-like, plate-like or coiled spring member and has appropriate coefficients of elasticity and damper for flexibly supporting the weight contact 411b.

For example, thus, the weight contact 411b will not be brought into contact the grounding contact 411a under a vibration equal to or lower than ½ cycles (acceleration) and will not follow a vibration equal to or higher than 5 cycles (acceleration).

The contact signal at the weight contact 411b is inputted into a Schmitt trigger circuit ST through a pull-up resistor R1, thereby improving its noise resistance. The output signal S of the Schmitt trigger circuit is inputted into the CPU 402 through cables 4.

In this way, the vibration sensors 411 can detect the motions of the player's arms as in the mercury switches 410.

Operations in a plurality of operation means may be instructed together to the player, rather than separate action instructions from the respective operation means as described in connection with FIG. 6.

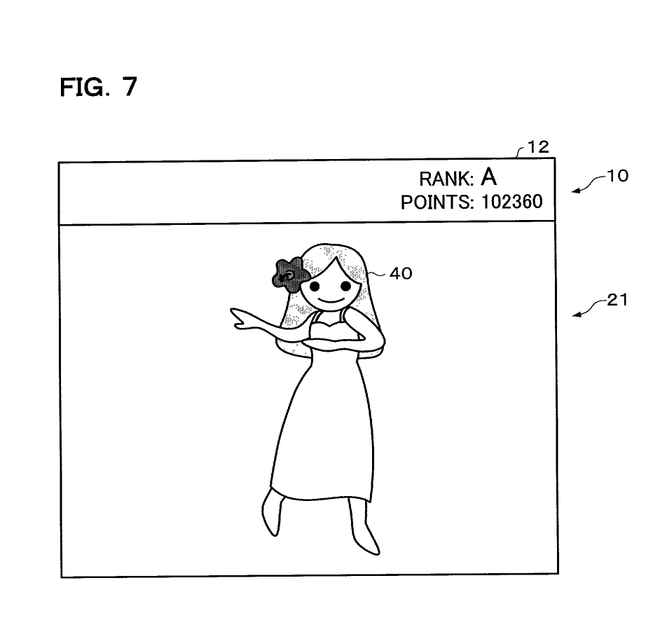

FIG. 7 is a view showing another game image according to this embodiment.

For example, as shown by a game image 12 in FIG. 7, the instruction area 21 may display a character 40 dancing the hula. In such a case, the action of the character 40 is provided to the player as a sample. The player will imitate the action of the character 40.

This provides a comprehensible operational instruction to the player when the action of the player is imitated to form a sample action. Moreover, the player can confirm its own action and can play the game while enjoying the sample picture and player's action.

It is of course that the character 40 shown in FIG. 7 may be displayed on one scene together with the operational instruction shown in FIG. 6. Thus, the operational instruction can have both the strictness and comprehensiveness.

Furthermore, the operational instruction may be more simplified.

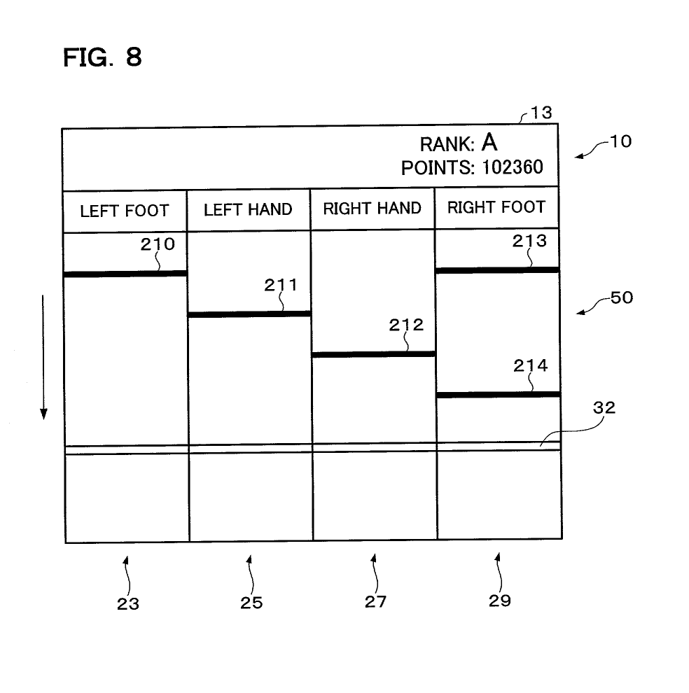

FIG. 8 is a view showing still another game image according to this embodiment.

This game image 13 includes an instruction area 50 and input instructions 210 to 214 which are instruction marks displayed on the instruction area 50 and which are of horizontally extending rod-shaped configuration.

These input instructions 210 to 214 are respectively displayed on left-foot instruction sub-area 23, left-hand instruction sub-area 25, right-hand instruction sub-area 27 and right-foot instruction sub-area 29 for the respective operation means.

A timing area 32 as an input mark is displayed in the form of a horizontally extending elongated rod across the game image 13. In such a case, the player must perform an operation at an optimal timing. In this regard, the timing area 32 is different from the timing area 30 which has a predetermined time range of five seconds required for the input instruction 20 and others to move from the starting point to the finishing point (scroll time).

Since the player must perform an operation at an optimal timing in such a manner, the player can enjoy the game in a tenser manner.

A character acting in synchronization with the timing of the player's action may be displayed on the same scene as the operational instruction image.

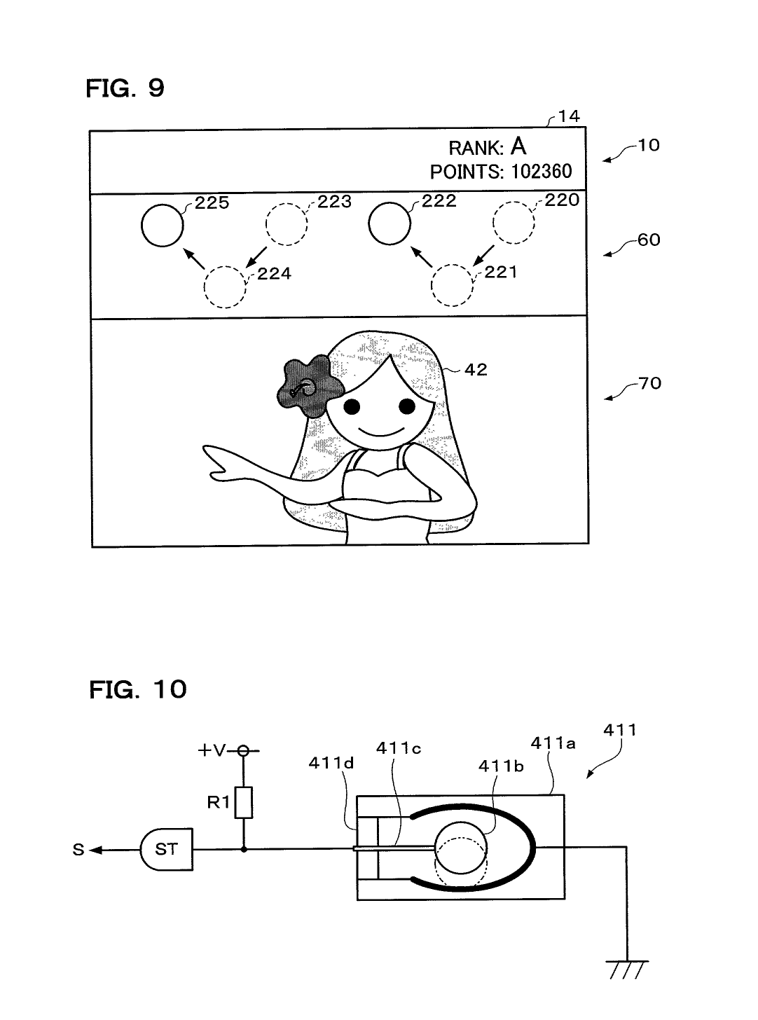

FIG. 9 is a view showing a further game image according to this embodiment.

In the game image 14 of FIG. 9, left-hand input instructions 220 to 222 and right-hand input instructions 223 to 225 are simultaneously displayed on an instruction area 60 on which an image for performing the instruction before the player acts is displayed.

The input instructions 220 and 223 are respectively moved leftward and downward from their initial state to the positions of the input instructions 221 and 224 and leftward and upward to the positions of the input instructions 222 and 225.

This means that the instruction is made such that the player moves both the right and left hands leftward and downward once and then leftward and upward.

On the other hand, the player moves both the right and left hands on which the arm-operating bands 2-1 and 2-2 are respectively attached leftward and downward once and then leftward and upward while viewing the input instruction 220 and others.

Each of the arm-operating bands 2 is provided with an inclination sensor 8 which includes a mercury switch and functions as inclination detection means.

The game image 14 also includes another instruction area 70 for displaying an image for instructing an operation in synchronization with the player's action, a character 42 being displayed on the instruction area 70.

The character 42 begins to act at a point when the input instructions 220 and 223 have respectively moved to the positions of the input instructions 222 and 225 and if a series of operational instructions are terminated.

The character 42 acts according to the motions of the input instructions 220 and others as in the player.

Therefore, the player can be instructed relating to the manner of arm action by initially viewing the input instructions in the instruction area 60 and act according to the instructions. Furthermore, the player can confirm his or her own entire action by viewing the character 42 of human-like configuration in the instruction area 70 even though the player is acting.

Particularly, where a complicated music game such as hula and Para Para dance, in which the motions of the arms are important, is to be made, the player can better play the game since he or she can re-confirm his or her action during the action.

Although the aforementioned embodiment has been described as to the operation sections 120 which is in the form of arm-operating bands 2 wound around the player's arms, these operation sections 120 may be attached on any other body parts such as feet, head, hip, fingers and others for grasping their motions. For example, with the hula, the motion of the player's hip is important. If the operation sections 120 are attached on the player's hip, the motion thereof can be detected.

Although the aforementioned embodiment has been described as to the operation sections comprising the inclination sensors 8 with the mercury switches 410 and the pressure-sensitive type sensor 412, the present invention is not limited to such operation sections, but may comprise any other suitable means as far as it can grasp the player's operation by detecting at least one of the movement volume, inclination, position and vibration in each of the operation sections which are in contact with part of the player's body or garment.

More particularly, such operation sections may include, for example, analog output type rotary encoders, digital output type rotary encoders using photo-interrupters, inclination sensors having mercury switches, geomagnetism sensors, gyros and so on.

For example, when an inclination sensor 8 is replaced by an infrared sensor, light-receiving means which detects the infrared light from the infrared sensor may be located on the housing 9. The output of the light-receiving means may be used to detect changes on the positions of the player's arms.

Although the aforementioned embodiment has been described as to the arm-operating bands 2 detachably wound around the player's arms, they may be replaced by any other suitable means such as clips anchored onto the cuffs of the player's garment, split rings attached around the player's wrists, foot gears such as sandals, caps, hats or helmets.

It is further preferred that the detection section 160 has no output if the player's action is detected out of a predetermined effective range.

This enables an appropriate evaluation to be made without any error.

Where a plurality of players are to play a game together, it is preferred that the judgment section 116 comprehensively judges the total conformance on the players' operations.

Thus, the players can play the game in the friendly manner since the evaluation will not be improved if they do not cooperate with one another.

For example, where two players are to play a game, a screen may display a massage “GOOD” if only one player executes an appropriate operation and another massage “GOOD COMBINATION” if both the two players execute appropriate operations.

When the total conformance on the plural players is made to perform a display different from that of a single player, the motivation can be provided to all the players for playing the game together. This provides a more amusing game.

If the game system 100 shown in FIG. 1 is to be used by two players, there may be provided two pairs of arm-operating bands 2 and two pairs of foot-operating panels 3.

Although the means which inputs the operational information may be in the form of wireless transmission means in addition to the wire transmission means such as cables 4, the latter is preferred. This is because the operational information can be transmitted in the easy and economical manner and maintained in the easy manner.

The present invention is not limited to the dancing game, but may be applied to any of various other games which detect the player's action.

Explanation on a Game System without Contacting with a Player

A game system without contacting with a player will now be described.

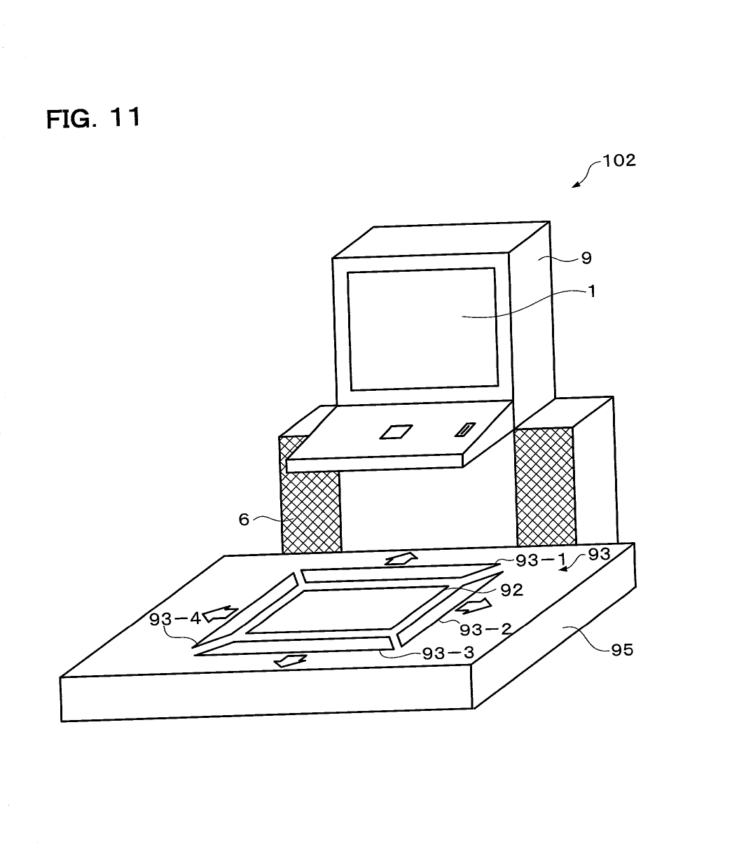

FIG. 11 shows an outline drawing of a game system 102 according to this embodiment.

A music game of this embodiment is a music game for hula. When the game system 102 is outputting a BGM (Back Ground Music) for hula, a player manipulates operation sections according to an operational input instruction which is displayed in association with the BGM. If the operations of the player fit the operational instruction, an effect sound such as the voice of a singer and so on will be outputted from the game system 102.

The game system 102 includes a loud speaker 6 that is one part of sound generation means which generates the BGM and effect sound and a display 1 that is one part of operational instruction means which performs the operational instruction associated with the BGM relative to the player.

The player inserts a coin through a coin input port and plays a game after a desired piece of music has selected from a menu displayed on the display 1 through operation buttons.

In particular, when the music game is one involving many motions of arms such as hula, it is important for appealing to the player by interest of the game that these motions of arms are instructed and adequately evaluated.

This embodiment is to detect a stepping motion and motions of hands.

The game system 102 comprises infrared sensors 93 functioning as a detection section for detecting the action of a player and for inputting the operational information relating to the player.

Four infrared sensors 93-1 to 93-4 are located around a player area 92 on which the player is to stand.

The player extends the right arm rightward when an operational instruction of extending the right arm rightward from the player area 92 is displayed on the display 1 and the left arm leftward when an operational instruction of extending the left arm leftward from the player area 92.

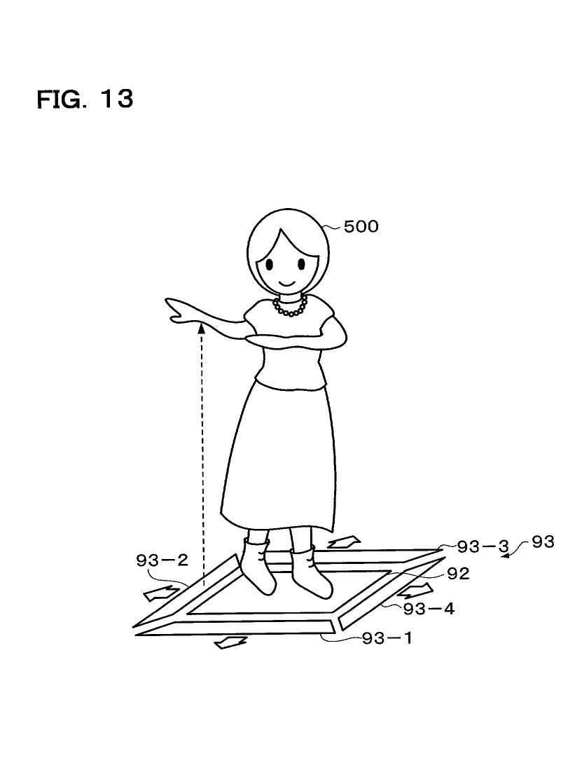

FIG. 13 shows a schematic diagram illustrating the detection of the player's action.

When the player extends the right arm outward from the player area 92 as shown in FIG. 13, the infrared sensor 932 positioned on the right side of the player area 92 detects the right arm of the player. Since the distance between each of the player's arms and the corresponding infrared sensor 93 is different from the distance between each of the player's feet and the same infrared sensor 93, each of the player's feet can also be detected by the infrared sensors 93 without any misdetection even if that foot is extended outward from the player area 92.

The operational information of the player from the infrared sensors 93 is sent to a processing section in a housing 9.

The processing section comprises evaluation means which evaluates the operation made by the player according to an operational instruction, based on the contents of the operational instruction and the operational information of the player.

In such an arrangement, the game system 102 can grasp the motions of the player's body parts such as arms and feet.

Thus, a game can be provided which is more amusing than the conventional stepping-only or button depression type games and which can evaluate the action in various body parts such as arms, hip and so on.

Thus, the player can longer enjoy the game without spoiling of the player's interest.

Next, description is made of functional blocks for realizing such functions.

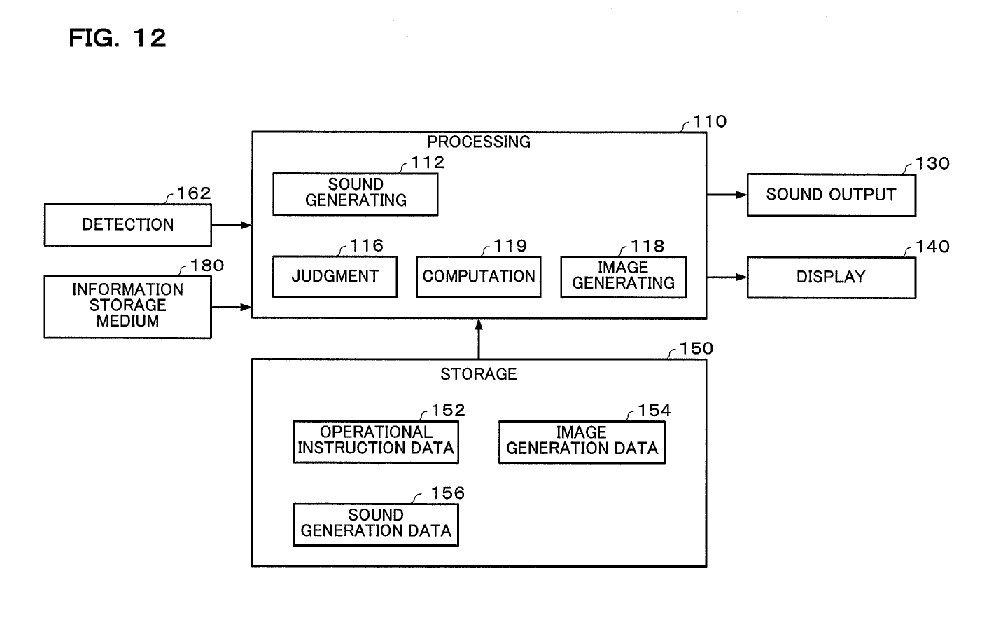

FIG. 12 is a functional block diagram of the game system 102 according to this embodiment.

The game system 102 comprises a detection section 162 for detecting the action of the player according to the operational input instruction displayed on the screen depending on a music being played and a processing section 110 for generating images and voices and judging the conformance in the player's operation, based on the operational information from the detection section 162.

The processing section 110 comprises a judgment section 116 for judging the conformance in the player's operation, based on the player's operational information delivered from the detection section 162, the contents of the operational instruction and the operational instruction data 152 for indicating timings, and a sound generating section 112 for generating the effect sound using sound generation data 156, based on the judgment in the judgment section 116.

The processing section 110 also comprises an image generating section 118 for displaying operational input instructions, characters and the like, based on the operational instruction data 152 and image generation data 154.

The processing section 110 further comprises a computation section 119 for computing scores and the like based on the judgment result.

The game system 102 further comprises a display section 140 for displaying the generated image and a sound output section 130 for outputting the generated sound.

The operational instruction data 152, image generation data 154 and sound generation data 156 are stored in a storage section 150.

In the other aspect, the game system 102 comprises the sound generating section 112 and sound output section 130 which function as sound generation means which generates game music sounds; the image generating section 118 and display section 140 which function as operational instruction means which performs the operational instruction associated with the game music sounds; the judgment section 116, computation section 119, image generating section 118 and display section 140 which function as evaluation means which evaluates the player's operation according to the operational instruction; and the detection section 162 for detecting the player's action.

The judgement section and the like can be realized by reading information out of an information storage medium 180.

The aforementioned information may include, for example, information for realizing the sound generation means which generates the game music sound, the operational instruction means which performs the operational instruction associated with the game music sound, and the evaluation means which detects the contents of the operational instruction and player's action and for evaluating the player's operation according to the operational instruction, based on the operational information from the plural input means which inputs the operational information relating the player.

The information stored in the information storage medium 180 may be replaced by information embodied in carrier wave. In other words, the game system can realize various functions mentioned above by reading the information from a predetermined host terminal or the like through a network, rather than from the information storage medium 180.

The information stored in the information storage medium 180 may also be replaced by a program for realizing the means.

The actual operational instruction will be described in a concrete manner.

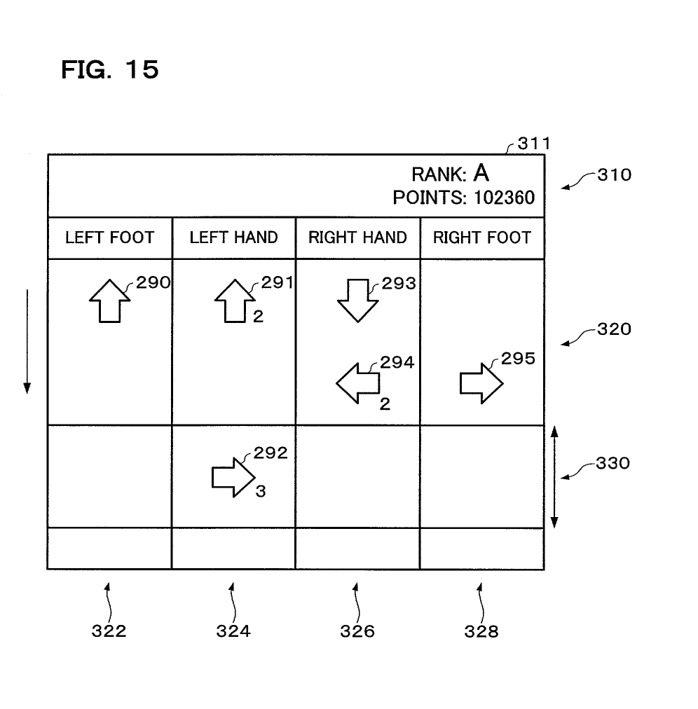

FIG. 15 is a view showing a game image according to this embodiment.

The game image 11 includes an evaluation area 310 for displaying ranks such as “Rank A” and the like and scores such as “102360 Points” and the like, an instruction area 320 for displaying input instructions 290 to 295 that are instruction marks showing operational instructions to the player, and a timing area 330 which displays an input instruction for indicating that an operation must be performed for each of the input instructions 290 to 295 in the instruction area.

The rank such as “Rank A” rises from C through B toward A as the evaluation relative to the player's operation rises and falls from A through B toward C as the evaluation falls.

If the player performs an operation agreeing with the instruction mark while it is on the input mark, a higher evaluation can be provided.

The scores such as “102360 Points” also rises as the evaluation for the player's operation rises and falls as the evaluation falls.

The instruction area 320 includes four sub-areas corresponding to the operations of the respective player's body parts, left foot instruction sub-area 322, left hand instruction sub-area 324, right hand instruction sub-area 326 and right foot instruction sub-area 328.

Each of the input instructions 290 to 295 appears on the top of the corresponding instruction sub-area and moves downwardly and disappears at a point when it passes through the timing area 330.

The timing area 330 has a predetermined range such that the player may perform the operation corresponding to each of the input instructions 290 to 295 while they fall within the range.

For example, the input instruction 290 is an instruction for the player to move the left leg forward from the player area 92, and the input instruction 295 is an instruction for the player to move the right leg rightward from the player area 92.

The flow of processing using the aforementioned judgment section 116 and others will be described below.

FIG. 4 is a flow chart illustrating a flow of processing according to this embodiment.

The image generating section 118 and display section 140 display the input instructions 290 and others, based on the operational instruction data 152 (step S2).

A player judges objects to be operated, operating manners and operational timings in the input instruction 290 and others and then makes an action conformable to the operational instructions.

The player's action is detected by the infrared sensors 93 (step S4).

More particularly, with the input instruction 292, the infrared sensor 93-4 located on the left side of the player area 92 detects the outward extension of the left hand.

Next, the judgment section 116 judges whether or not such an operation is performed within the instructed range, that is, whether or not the outward extension of the left hand are detected while the input instruction 292 exists in the timing area 330 shown in FIG. 15 and more particularly for 0 to 5 seconds (step S6).

If such a condition is fulfilled, the judgment section 116 further compares the number of instructions with the number of operations actually made by the player (step S8).

If the number of instructions coincides with the number of operations actually made by the player, the computation section 119 adds the scores, the image generating section 118 and display section 140 change (or upgrade) the rank and the sound generating section 112 and sound output section 130 output an effect sound for conformance, thereby generating the special effect (step S12).

If the number of instructions is more than the number of operations actually made by the player, the number of operations is incremented by one (1) (step S10). Thereafter, the next detection of operation is executed (step S4).

If the number of instructions is less than the number of operations actually made by the player, it is judged that the player wrongly makes the operations. Thus, the computation section 119 subtracts the scores, the image generating section 118 and display section 140 change (or downgrade) the rank and the sound generating section 112 and sound output section 130 output an effect sound for inconformance, thereby generating a special effect (step S14).

Even if an operation of the player out of the instructed range is detected, the scores are subtracted (step S14).

Such a procedure will be repeated until that piece of music terminates (step S16).

According to this embodiment, thus, the action of the player's arms and others can be grasped by providing a plurality of infrared sensors 93-1 to 93-4 in a plurality of directions.

By adopting such a technique, a game can be provided which is more amusing than the conventional stepping-only or button depression type games and which can evaluate the action in various body parts such as arms, hip and so on.

As shown in FIG. 15, furthermore, this embodiment is designed to display, on the display 1, various types of input instructions 290 and others which correspond to the legs and arms and which correspond to a plurality of operation types additionally containing rotations, directions and so on.

If a plurality of operational instructions are provided, the player will be involved in the game to properly select one of the operations and to perform that operation at its optimal timing. This enables the game to be more amusing.

Therefore, a more amusing game can be provided in which various instructions and operations are provided by making various operational instructions to the respective body parts of the player.

Particularly, since such operational instructions can be provided in real time, the player can enjoy the game in a tenser manner.

Moreover, this embodiment indicates a timing whereat the player should perform an operation as an operational instruction as shown in the timing area 330 of FIG. 15 and causes the judgment section 116 to evaluate the conformance between the contents of the operational instruction and the actual operation made by the player.

Thus, an operational instruction may be performed which causes a predetermined operation to execute between a starting point and a finishing point. As a result, the player must exactly perform the operation at that timing and can thus enjoy the game in a tenser manner.

The judgment section 116 then evaluates the conformance between the contents of the operational instructions and the number of operations actually made by the player.

In such a manner, the game system can instruct the number of particular operations to be made by the player thereto. Thus, the player is required to make the instructed operations within the limited time period, so that the player can enjoy the game in a tenser manner.

Description will be made of a hardware configuration in each of the primary parts in the functional block shown in FIG. 12.

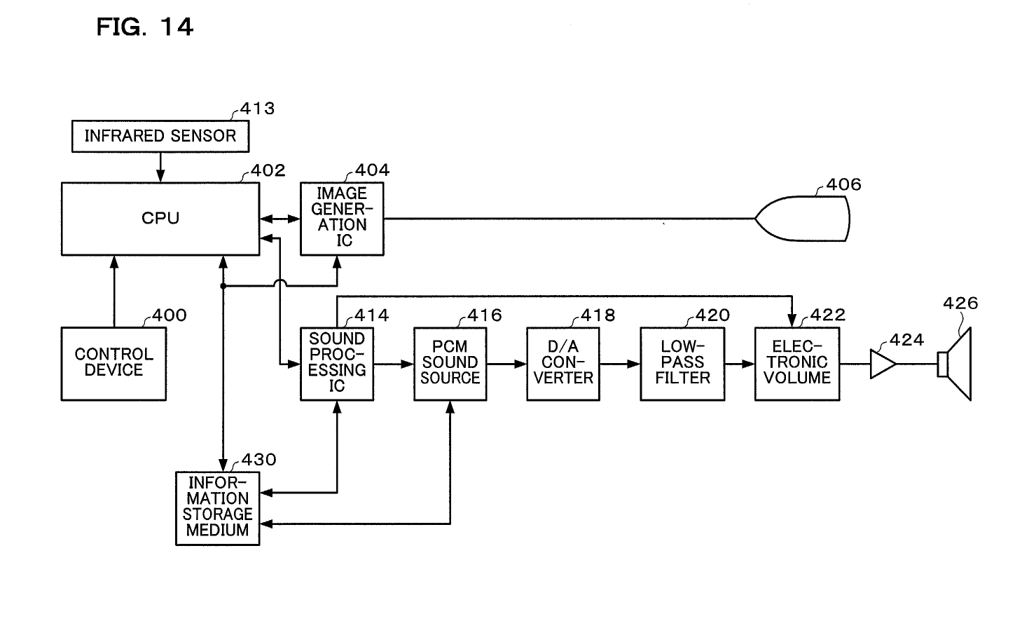

FIG. 14 is a view showing a hardware configuration of a game system according to this embodiment.

An information storage medium 430 is mainly operative to store programs, image data, sound data (including tone data, score data and waveform data) and so on. The information storage medium 430 may be in any form of CD-ROM, game cassette, IC card, MO, FD, DVD-ROM, memory and so on. For example, with the home game systems, the information storage medium for storing the game program and the like may be in any form of CD-ROM, DVD-ROM, game cassette and so on. With the arcade game systems, the information storage medium may be a memory such as ROM and the like.

A control device 400 corresponds to a control panel or the like and can be used to input player's judgment to the main system body depending on the progress of game.

There is further provided an infrared sensor section 413.

A CPU 402 is to receive menu selection information from the control device 400, and arm-action detection information and feet-action detection information from the infrared sensor section 413.

The CPU 402 performs the control of the entire game system, the processing of various data and the computation of game, based on the input signals and others inputted through the control device 400. The data and others read out of the information storage medium 430 are temporarily stored in any suitable storage means such as Ram (not shown). This RAM may also be used as a working area for the CPU 402, image generating IC 404, sound processing IC 414.

This game system further comprises the image generating IC 404 and sound processing IC 414 for optimally outputting sounds and images. Such image generating IC 404 and sound processing IC 414 may be in any form of dedicated IC, CPU or DSP, for example.

The image generating IC 404 is an integrated circuit for generating pixel information to be outputted toward the display 406, based on image data sent from RAM (not shown) or the information storage medium 430. The display 406 may be in the form of a so-called head mount display (HMD).

The sound processing IC 414 is operative to make various processings for generating game music, effect sounds, voices and others, based on the instructions from CPU 402 and the programs, tone data, score data and other data from the RAM and information storage medium 430.

A PCM sound source 416 is operative to generate and output digital sound signals toward a D/A converter 418, based on the processing result at the sound processing IC 414 and the waveform data from the information storage medium 430 and others (i.e., data representing the real physical waveforms of sounds such as drum, violin).

The D/A converter 418 converts these digital signals to analog signals which are in turn outputted therefrom toward a low-pass filter 420. The output of the low-pass filter 420 is inputted into an electronic volume 422.

The electronic volume 422 adjusts the loudness according to instructions from the sound processing IC 414. The output of the electronic volume 422 is input into a loud speaker 426 through an amplifier 424, the loud speaker 426 then externally outputting the game music, the effect sound and the voices.

Thus, the aforementioned operation section 120 may be realized by the control device 400 and infrared sensor section 413; the information storage medium 180 and storage section 150 may be realized by the information storage medium 430; the judgment section 116 and computation section 119 maybe realized by the CPU 402; the sound generating section 112 may be realized by the sound processing IC 414, PCM sound source 416, D/A converter 418 and low-pass filter 420; the sound output section 130 may be realized by the amplifier 424, electronic volume 422 and loud speaker 426; the image generating section 118 may be realized by the image generating IC 404; and the display section 140 may be realized by the display 406.

The game system 102 without contacting with a player is not limited to the aforementioned embodiment, but may be carried out in any of various other forms.

For example, the infrared sensors 93 may be replaced by a camera which functions as imaging means which detects the player's action.

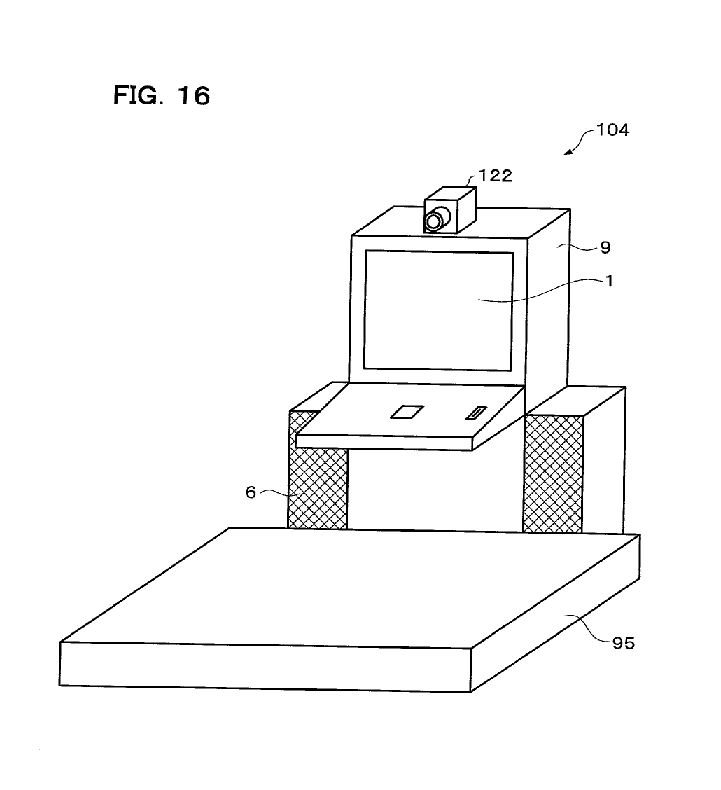

FIG. 16 shows a perspective view of a game system 104 comprising a camera 122.

The game system 104 comprises a camera 122 located on the top of a housing 9 above a display 1 in place of the infrared sensors 93.

The camera 122 sends its image information to the judgment section 116 which in turn judges and evaluates the player's action, based on the image information, as described.

This can also detect the motions of the player's body parts such as arms, feet and others, as in the infrared sensors 93.

Operations in a plurality of operation means may be instructed together to the player, rather than separate action instructions from the respective operation means as described in connection with FIG. 15.

FIG. 7 is a view showing another game image according to this embodiment.

For example, as shown by a game image 12 in FIG. 7, the instruction area 21 may display a character 40 dancing the hula. In such a case, the action of the character 40 is provided to the player as a sample. The player will imitate the action of the character 40.

This provides a comprehensible operational instruction to the player when the action of the player is imitated to form a sample action. Moreover, the player can confirm its own action and can play the game while enjoying the sample picture and player's action.

It is of course that the character 40 shown in FIG. 7 may be displayed on one scene together with the operational instruction shown in FIG. 15. Thus, the operational instruction can have both the strictness and comprehensiveness.

Furthermore, the operational instruction may be more simplified.

FIG. 8 is a view showing still another game image according to this embodiment.

This game image 13 includes an instruction area 50 and input instructions 210 to 214 which are instruction marks displayed on the instruction area 50 and which are of horizontally extending rod-shaped configuration.

These input instructions 210 to 214 are respectively displayed on left-foot instruction sub-area 23, left-hand instruction sub-area 25, right-hand instruction sub-area 27 and right-foot instruction sub-area 29 for the respective operation means.

A timing area 32 as an input mark is displayed in the form of a horizontally extending elongated rod across the game image 13. In such a case, the player must perform an operation at an optimal timing. In this regard, the timing area 32 is different from the timing area 30 which has a predetermined time range of five seconds required for the input instruction 20 and others to move from the starting point to the finishing point (scroll time).

Since the player must perform an operation at an optimal timing in such a manner, the player can enjoy the game in a tenser manner.

A character acting in synchronization with the timing of the player's action may be displayed on the same scene as the operational instruction image.

FIG. 9 is a view showing a further game image according to this embodiment.

In the game image 14 of FIG. 9, left-hand input instructions 220 to 222 and right-hand input instructions 223 to 225 are simultaneously displayed on an instruction area 60 on which an image for performing the instruction before the player acts is displayed.

The input instructions 220 and 223 are respectively moved leftward and downward from their initial state to the positions of the input instructions 221 and 224 and leftward and upward to the positions of the input instructions 222 and 225.

This means that the instruction is made such that the player moves both the right and left hands leftward and downward once and then leftward and upward.

On the other hand, the player moves both the right and left hands leftward and downward once and then leftward and upward while viewing the input instructions 220 and others.

The game image 14 also includes another instruction area 70 for displaying an image for instructing an operation in synchronization with the player's action, a character 42 being displayed on the instruction area 70.

The character 42 begins to act at a point when the input instructions 220 and 223 have respectively moved to the positions of the input instructions 222 and 225 and if a series of operational instructions are terminated.

The character 42 acts according to the motions of the input instructions 220 and others as in the player.

Therefore, the player can be instructed relating to the manner of arm action by initially viewing the input instructions in the instruction area 60 and act according to the instructions. Furthermore, the player can confirm his or her own entire action by viewing the character 42 of human-like configuration in the instruction area 70 even though the player is acting.

Particularly, where a complicated music game such as hula and Para Para dance, in which the motions of the arms are important, is to be made, the player can better play the game since he or she can re-confirm his or her action during the action.

Although the motion of arms and legs are detected in the aforementioned embodiment, the motion of other parts of the body such as head, waist and fingers can also be detected.

Further, the aforementioned embodiment has been described as to means which detects the player's action without contact which is in the form of the infrared sensors 93 or camera 122, such detection means is not limited to such a device.

More particularly, for example, a plurality of proximity sensors for sensing the proximity of each of the player's body parts to a predetermined location on the housing may be provided on the top and bottom of the housing.

For example, when an operational instruction of upward moving the player's right arm is provided and if the player moves the right arm upward, it can be detected by one of the proximity sensors that is on the right and upper portion of the housing.

It is further preferred that the detection section 162 has no output if the player's action is detected out of a predetermined effective range.

This enables an appropriate evaluation to be made without any error.

Where a plurality of players are to play a game together, it is preferred that the judgment section 116 comprehensively judges the total conformance on the players' operations.

Thus, the players can play the game in the friendly manner since the evaluation will not be improved if they do not cooperate with one another.

For example, where two players are to play a game, a screen may display a massage “GOOD” if only one player executes an appropriate operation and another massage “GOOD COMBINATION” if both the two players execute appropriate operations.

When the total conformance on the plural players is made to perform a display different from that of a single player, the motivation can be provided to all the players for playing the game together. This provides a more amusing game.

If the game system 102 shown in FIG. 11 is to be used by two players, there may be provided two pairs of play areas 92 and two pairs of infrared sensors 93.

The present invention is not limited to the dancing game, but may be applied to any of various other games which detect the player's action.

What is claimed is:

1. A game system comprising:
sound generation means which generates a sound for game music;
operational instruction means which gives a player an operational instruction associated with a sound for game music;
a plurality of input means which detect a motion of the player and inputs operational information of the player; and
evaluation means which evaluates an operation of the player according to the operational instruction, based on a content of the operational instruction and the operational information,
wherein each of the input means includes:
an operation section which moves along with the player; and
a detection section which detects at least one of movement volume, inclination, position and vibration of the operation section.

2. The game system according to claim 1,
wherein the operation section includes a detachable section which is detachable to each body part of the player, and
wherein the detection section detects at least one of movement volume, inclination, position and vibration of each body part of the player on which the operation section is attached with the detachable section.

3. The game system according to claim 1
wherein the operation section includes a step pedestal having an input indication mark corresponding to the operational instruction, and
wherein the detection section includes means which detects a contact or pressure of the player against the step pedestal.

4. The game system according to claim 1,
wherein the operational instruction means provides one or more operational instructions corresponding to a plurality of the operation sections.

5. The game system according to claim 1,
wherein the operational instruction means displays at least one of a schematic display including a color, pattern or input action, and number of input as the operational instruction.

6. The game system according to claim 1,
wherein the operational instruction means displays a sample operational instruction imitating an action of the player as the operational instruction before an input of the player has been received.

7. The game system according to claim 1,
wherein the operational instruction means performs an instruction using one or more instruction marks which instructs an input operation and one or more input marks which indicates an input timing, and
wherein the evaluating means includes judgment means which judges a conformance of an operation by the player to a given condition when there is a given positional relationship between the instruction mark and the input mark.

8. The game system according to claim 7,
wherein the input mark schematically shows a duration of input or an area in which timing is judged.

9. The game system according to claim 7,
wherein the operational instruction means displays a mark for an input judgement and which indicates at least one of input timing, input period, number of inputs, direction of input and magnitude of input as the instruction mark, and
wherein the judgment means judges the conformance of the operation by the player to a given condition when there is a given positional relationship between the instruction mark and the input mark.

10. The game system according to claim 1,
wherein the operational instruction means performs at least one of an instruction of moving a hand in a rightward-leftward direction or an upward-downward direction, an instruction of rotating a hand clockwise or counterclockwise and an instruction of moving a hand in a zigzag manner, as the operational instruction.

11. The game system according to claim 2,
wherein the detection section includes a sensor which outputs digital information including at least one of movement volume, inclination, position and vibration of each body part of the player on which the operation section is attached with the detachable section.

12. The game system according to claim 2,
wherein the detection section includes a sensor which outputs analog information including at least one of movement volume, inclination, position and vibration of each body part of the player on which the operation section is attached with the detachable section.

13. A game system comprising:
a sound generation section which generates a sound for game music;
a motion instruction section which gives a player a motion instruction associated with a sound for game music;
a plurality of input sections which detect a motion of the player and inputs motion information of the player; and
an evaluation section which evaluates a motion of the player according to the motion instruction, based on a content of the motion instruction and the motion information,
wherein each of the input sections includes:
an operation section which moves along with the player; and
a detection section which detects an inclination in a rightward-leftward direction and an upward-downward direction of the operation section.

14. A game system comprising:
a sound generation section which generates a sound for game music;
a motion instruction section which gives a player a motion instruction associated with a sound for game music;
a plurality of input sections which detect a motion of the player and inputs motion information of the player; and
an evaluation section which evaluates a motion of the player according to the motion instruction, based on a content of the motion instruction and the motion information,
wherein each of the input sections includes:
an operation section which moves along with the player; and
a detection section which detects an inclination in a rightward-leftward direction and an upward-downward direction of the operation section,
wherein the motion instruction section performs at least one of an instruction of moving a hand in a rightward-leftward direction or an upward-downward direction, an instruction of rotating a hand clockwise or counter-clockwise and an instruction of moving a hand in a zigzag manner, as the motion instruction,
wherein the operation section which moves along with the player's arm, and
wherein the input section detects a change of an inclination of the arm based on information from the detection section.

15. A game system comprising:
sound generation means which generates a sound for game music;
operational instruction means which gives a player an operational instruction associated with a sound for game music;
input means which detects a motion of the player and inputs operational information of the player; and
evaluation means which evaluates an operation of the player according to the operational instruction, based on a content of the operational instruction and the operational information,
wherein the input means includes a detection section which detects at least one of movement volume, inclination and position of each body part of the player, without contacting with the player.

16. The game system according to claim 15,
wherein the detection section includes a plurality of infrared sensors or a plurality of proximity sensors.

17. The game system according to claim 15,
wherein the input means includes imaging means, and
wherein the detection section detects an action of the player, based on imaging information from the imaging means.

18. The game system according to claim 15,
wherein the operational instruction means provides one or more operational instructions to a plurality of operation sections.

19. The game system according to claim 15,
wherein the operational instruction means displays at least one of a schematic display including a color, pattern or input action, and number of input as the operational instruction.

20. The game system according to claim 15,
wherein the operational instruction means displays a sample operational instruction imitating an action of the player as the operational instruction before an input of the player has been received.

21. The game system according to claim 15,
wherein the operational instruction means performs an instruction using one or more instruction marks which instructs an input operation and one or more input marks which indicates an input timing, and
wherein the evaluating means includes judgment means which judges a conformance of an operation by the player to a given condition when there is a given positional relationship between the instruction mark and the input mark.

22. The game system according to claim 21,
wherein the input mark schematically shows a duration of input or an area in which timing is judged.

23. The game system according to claim 21,
wherein the operational instruction means displays a mark for an input judgement and which indicates at least one of input timing, input period, number of inputs, direction of input and magnitude of input as the instruction mark, and
wherein the judgment means judges the conformance of the operation by the player to a given condition when there is a given positional relationship between the instruction mark and the input mark.

24. The game system according to claim 15,
wherein the operational instruction means performs at least one of an instruction of moving a hand in a rightward-leftward direction or an upward-downward direction, an instruction of rotating a hand clockwise or counter-clockwise and an instruction of moving a hand in a zigzag manner, as the operational instruction.

25. A game system comprising:
a sound generation section which generates a sound for game music;
a motion instruction section which gives a player a motion instruction associated with a sound for game music;
a detection section which detects a motion of the player and inputs motion information of the player; and
an evaluation section which evaluates a motion of the player according to the motion instruction, based on a content of the motion instruction and the motion information,
wherein the detection section detects at least one of movement volume, inclination and position of each body part of the player, without contacting with the player,
wherein the motion instruction section performs an instruction using one or more instruction marks which instructs a motion of each body part of the player and one or more input marks which indicates a motion timing, and
wherein the evaluation section includes a judgment section which judges a conformance of a motion by the player to a given condition when there is a given positional relationship between the instruction mark and the input mark.

26. A game system comprising:
a sound generation section which generates a sound for game music;
a motion instruction section which gives a player a motion instruction associated with a sound for game music;
a detection section which detects a motion of the player and inputs motion information of the player; and
an evaluation section which evaluates a motion of the player according to the motion instruction, based on a content of the motion instruction and the motion information,
wherein the motion instruction section instructs a motion of each body part of the player, and
wherein the detection section detects at least one of movement volume, inclination and position of each body part of the player, without contacting with the player.

27. The game system according to claim 25,
wherein the detection section includes a plurality of infrared sensors or a plurality of proximity sensors, and detects at least one of movement volume and inclination of each body part of the player based on the plurality of infrared sensors or the plurality of proximity sensors.

28. A computer-usable program embodied in a carrier wave or on an information storage medium, the program being for an evaluation of a player's operation relating to an operational instruction associated with a sound for game music, and for a computer to realize:
sound generation means which generates a sound for game music;
operational instruction means which gives a player an operational instruction associated with a sound for game music; and
evaluation means which evaluates an operation of the player according to the operational instruction, based on a content of the operational instruction and operational information of the player from a given input means,
wherein the input means includes:
an operation section which moves along with the player; and
a detection section which detects at least one of movement volume, inclination, position and vibration of the operation section.

29. The program according to claim 28,
wherein the operation section includes a detachable section which is detachable to each body part of the player, and
wherein the detection section detects at least one of movement volume, inclination, position and vibration of each body part of the player on which the operation section is attached with the detachable section.

30. The program according to claim 28,
wherein the operation section includes a step pedestal having an input indication mark corresponding to the operational instruction, and
wherein the detection section includes means which detects a contact or pressure of the player against the step pedestal.

31. The program according to claim 28,
wherein the operational instruction means provides one or more operational instructions corresponding to a plurality of the operation sections.

32. The program according to claim 28,
wherein the operational instruction means displays at least one of a schematic display including a color, pattern or input action, and number of input as the operational instruction.

33. The program according to claim 28,
wherein the operational instruction means displays a sample operational instruction imitating an action of the player as the operational instruction before an input of the player has been received.

34. The program according to claim 28,
wherein the operational instruction means performs an instruction using one or more instruction marks which instructs an input operation and one or more input marks which indicates an input timing, and
wherein the evaluating means includes judgment means which judges a conformance of an operation by the player to a given condition when there is a given positional relationship between the instruction mark and the input mark.

35. The program according to claim 34,
wherein the input mark schematically shows a duration of input or an area in which timing is judged.

36. The program according to claim 34,
wherein the operational instruction means displays a mark for an input judgement and which indicates at least one of input timing, input period, number of inputs, direction of input and magnitude of input as the instruction mark, and
wherein the judgment means judges the conformance of the operation by the player to a given condition when there is a given positional relationship between the instruction mark and the input mark.

37. The program according to claim 28,
wherein the operational instruction means performs at least one of an instruction of moving a hand in a rightward-leftward direction or an upward-downward direction, an instruction of rotating a hand clockwise or counterclockwise and an instruction of moving a hand in a zigzag manner, as the operational instruction.

38. The program according to claim 28,
wherein the detection section includes a sensor which outputs digital information including at least one of movement volume, inclination, position and vibration of each body part of the player on which the operation section is attached with the detachable section.

39. The program according to claim 28,
wherein the detection section includes a sensor which outputs analog information including at least one of movement volume, inclination, position and vibration of each body part of the player on which the operation section is attached with the detachable section.

40. A computer-usable program embodied in a carrier wave or on an information storage medium, the program being for an evaluation of a player's operation relating to a motion instruction associated with a sound for game music, and for a computer to realize:
a sound generation section which generates a sound for game music;
a motion instruction section which gives a player a motion instruction associated with a sound for game music; and
an evaluation section which evaluates motion of the player according to the motion instruction, based on a content of the motion instruction and the motion information from a given input section,
wherein the input section includes:
an operation section which moves along with the player; and
a detection section which detects an inclination in a rightward-leftward direction and an upward-downward direction of the operation section.

41. A computer-usable program embodied in a carrier wave or on an information storage medium, the program being for an evaluation of a player's motion relating to a motion instruction associated with a sound for game music, and for a computer to realize:
a sound generation section which generates a sound for game music;
a motion instruction section which gives a player a motion instruction associated with a sound for game music; and
an evaluation section which evaluates motion of the player according to the motion instruction, based on a content of the motion instruction and the motion information from a given input sections,
wherein the input sections includes:
an operation section which moves along with the player; and
a detection section which detects an inclination in a rightward-leftward direction and an upward-downward direction of the operation section,
wherein the motion instruction section performs at least one of an instruction of moving a hand in a rightward-leftward direction or an upward-downward direction, an instruction of rotating a hand clockwise or counter-clockwise and an instruction of moving a hand in a zigzag manner, as the motion instruction,
wherein the operation section moves along with the player's arm, and
wherein the input section detects a change of an inclination of an arm based on information from the detection section.

42. A computer-usable program embodied in a carrier wave or on an information storage medium, the program being for an evaluation of a player's operation relating to an operational instruction associated with a sound for game music, and for a computer to realize:
sound generation means which generates a sound for game music;
operational instruction means which gives a player an operational instruction associated with a sound for game music; and
evaluation means which evaluates an operation of the player according to the operational instruction, based on a content of the operational instruction and operational information of the player from a given input means,
wherein the input means includes a detection section which detects at least one of movement volume, inclination and position of each body part of the player, without contacting with the player.

43. The program according to claim 42,
wherein the detection section includes a plurality of infrared sensors or a plurality of proximity sensors.

44. The program according to claim 42,
wherein the input means includes imaging means, and
wherein the detection section detects an action of the player, based on imaging information from the imaging means.

45. The program according to claim 42,
wherein the operational instruction means provides one or more operational instructions to a plurality of operation sections.

46. The program according to claim 42,
wherein the operational instruction means displays at least one of a schematic display including a color, pattern or input action, and number of input as the operational instruction.

47. The program according to claim 42,
wherein the operational instruction means displays a sample operational instruction imitating an action of the player as the operational instruction before an input of the player has been received.

48. The program according to claim 42,
wherein the operational instruction means performs an instruction using one or more instruction marks which instructs an input operation and one or more input marks which indicates an input timing, and
wherein the evaluating means includes judgment means which judges a conformance of an operation by the player to a given condition when there is a given positional relationship between the instruction mark and the input mark.

49. The program according to claim 48,
wherein the input mark schematically shows a duration of input or an area in which timing is judged.

50. The program according to claim 48,
wherein the operational instruction means displays a mark for an input judgement and which indicates at least one of input timing, input period, number of inputs, direction of input and magnitude of input as the instruction mark, and
wherein the judgment means judges the conformance of the operation by the player to a given condition when there is a given positional relationship between the instruction mark and the input mark.

51. The program according to claim 42,
wherein the operational instruction means performs at least one of an instruction of moving a hand in a rightward-leftward direction or an upward-downward direction, an instruction of rotating a hand clockwise or counterclockwise and an instruction of moving a hand in a zigzag manner, as the operational instruction.

52. A computer usable program embodied in a carrier wave or on an information storage medium, the program being for an evaluation of a player's motion relating to an motion instruction associated with a sound for game music, and for a computer to realize:
a sound generation section which generates a sound for game music;
a motion instruction section which gives a player a motion instruction associated with a sound for game music;
a detection section which detects a motion of the player and inputs motion information of the player; and
an evaluation section which evaluates a motion of the player according to the motion instruction, based on a content of the motion instruction and the motion information,
wherein the detection section detects at least one of movement volume, inclination and position of each body part of the player, without contacting with the player,
wherein the motion instruction section performs an instruction using one or more instruction marks which instructs a motion of each body part of the player and one or more input marks which indicates a motion timing, and
wherein the evaluation section includes a judgment section which judges a conformance of a motion by the player to a given condition when there is a given positional relationship between the instruction mark and the input mark.

53. A computer usable program embodied in a carrier wave or on an information storage medium, the program being for an evaluation of a player's motion relating to an motion instruction associated with a sound for game music, and for a computer to realize:
a sound generation section which generates a sound for game music;
a motion instruction section which gives a player a motion instruction associated with a sound for game music;
a detection section which detects a motion of the player and inputs motion information of the player; and
an evaluation section which evaluates a motion of the player according to the motion instruction, based on a content of the motion instruction and the motion information,
wherein the motion instruction section instructs a motion of each body part of the player, and
wherein the detection section detects at least one of movement volume, inclination and position of each body part of the player, without contacting with the player.
